(19) United States
(12) Patent Application Publication
(10) Pub. No.: US 2014/0176561 A1
(43) Pub. Date: Jun. 26, 2014

(54) ULTRASOUND DATA PROCESSING DEVICE

(71) Applicant: Masashi Nakamura, Mitaka-shi (JP)

(72) Inventor: Masashi Nakamura, Mitaka-shi (JP)

(73) Assignee: HITACHI ALOKA MEDICAL, LTD., Mitaka-shi, Tokyo (JP)

(21) Appl. No.: 14/237,536

(22) PCT Filed: Aug. 15, 2012
(86) PCT No.: PCT/JP2012/070744

§ 371 Date: Feb. 6, 2014

(30) Foreign Application Priority Data
Aug. 17, 2011 (JP) 2011-178483

(51) Int. Cl. G06T 11/60; G06T 11/20

(52) U.S. Cl. CPC G06T 11/60; G06T 11/203
USPC 345/442

(57) ABSTRACT

A trace guide (TG) that has been set within a manual trace reference cross-section (58) is illustrated with a dashed line. The trace guide (TG) is obtained from three-dimensional contour information based on already-completed manual tracing of a first sheet. Therefore, the user draws a trace line (TL) corresponding to the contour of target tissue on a second sheet of the manual trace reference cross-section (58) while referring to the trace guide (TG) and also checking a tomographic image of the target tissue within the manual trace reference cross-section (58). The user may: draw the trace line (TL) in full; use apart of the trace guide (TG) without alteration as the trace line (TL) and correct the remaining part to serve as the trace line (TL); or use the trace guide (TG) without alteration as the trace line (TL).

### TECHNICAL FIELD

The present invention relates to an apparatus for processing ultrasound data obtained by transmitting and receiving ultrasound.

### BACKGROUND ART

There have been known ultrasound technologies that use three-dimensional data collected by scanning with an ultrasonic beam. For example, Patent Document 1 discloses a technique of three-dimensionally identifying a contour of a target tissue based on volume data collected from within a three-dimensional space containing the target tissue. This technique enables calculation of the volume of the target tissue, for example.

According to the technique disclosed in Patent Document 1, a plurality of automatic trace reference cross-sections and a plurality of manual trace reference cross-sections are set within a three-dimensional data space. Subsequently, in each of the manual trace reference cross-sections, a manual trace line showing the contour of the target tissue is formed in accordance with a user operation. Further, based on the manual trace lines formed in the plurality of manual trace reference cross-sections, trace lines are formed in each of the automatic trace reference cross-sections by performing an interpolation processing or the like. Based on a large number of trace lines formed within the three-dimensional data space in this manner, the contour of the target tissue is identified three-dimensionally.

According to the technique disclosed in Patent Document 1, even when precise extraction of the contour of the target tissue is not possible by performing binarization processing or the like, the contour of the target tissue can be identified with relative precision in accordance with user operation; i.e., in accordance with the user's judgment by visual observation, for example. In addition, Patent Document 1 describes that, according to its disclosed technique, by further automatically correcting the manual trace lines formed in accordance with user operations, the contour of the target tissue can be extracted with very high accuracy.

Concerning the processing that requires user operation, it is desirable to reduce the burden imposed on the user, for example. Further, it is desired that the ultimately obtained trace lines have high accuracy.

### PRIOR ART LITERATURE

### Patent Documents

Patent Document 1: JP 2008-142519 A

### SUMMARY OF THE INVENTION

### Objects to be Achieved by the Invention

In view of the above-described background art, the present inventors have conducted extensive research and development related to formation of trace lines in accordance with user operation.

The present invention was created in the course of the research and development. An object of the present invention is to provide an apparatus that assists user operation during formation of trace lines.

### MEANS FOR ACHIEVING THE OBJECTS

A preferred ultrasound data processing apparatus that achieves the above object is an ultrasound data processing apparatus for processing ultrasound data obtained by transmitting and receiving ultrasound with respect to a three-dimensional space containing a target, the apparatus comprising: a trace cross-section setting unit that sets a plurality of manual trace cross-sections within a three-dimensional data space constituted with three-dimensionally arranged ultrasound data; a trace line forming unit that forms, in each of the manual trace cross-sections, a trace line corresponding to a contour of the target in accordance with a user operation; a contour information generating unit that generates steric contour information of the target within the three-dimensional data space based on a manual trace cross-section having a trace line already formed therein; and a trace assisting unit that forms, in a manual trace cross-section in which a trace line is to be formed subsequently, a trace guide two-dimensionally reflecting the contour information, wherein the trace line forming unit forms, in a manual trace cross-section having the trace guide formed therein, a trace line in accordance with an operation performed by a user while referring to the trace guide.

According to the above-described preferred embodiment, a trace guide two-dimensionally reflecting the contour information is formed in a manual trace cross-section in which a trace line is to be formed subsequently, and the user forms the trace line while referring to the trace guide. Accordingly, the user's operation burden is reduced as compared to the case where no trace guide is provided. Further, compared to the case where no trace guide is provided, improvement in trace line accuracy can be expected.

While one preferred embodiment of the ultrasound data processing apparatus is an ultrasonic diagnostic apparatus, the ultrasound data processing apparatus may also be implemented with a computer or the like.

In a desirable embodiment, the trace line forming unit corrects a shape of the trace guide in accordance with a user operation and adopts the corrected trace guide as a trace line.

In a desirable embodiment, the contour information generating unit generates latest contour information based on manual trace cross-sections each having a trace line already formed therein while increasing number of the manual trace cross-sections every time a trace line is formed, and the trace assisting unit forms, in a manual trace cross-section in which a trace line is to be formed subsequently, a trace guide two-dimensionally reflecting the latest contour information.

In a desirable embodiment, the apparatus further comprises an image forming unit that forms a display image showing the latest contour information. Adequateness of the latest contour information is judged by a user via the display image, and, in accordance with the user's judgment, the trace cross-section setting unit adds a manual trace cross-section.

In a desirable embodiment, the apparatus further comprises a confirmation cross-section setting unit that sets a confirmation cross-section within the three-dimensional data space, and the image forming unit forms a display image showing the confirmation cross-section with the latest contour information two-dimensionally reflected therein.

In a desirable embodiment, the confirmation cross-section setting unit moves the confirmation cross-section within the three-dimensional data space to be substantially parallel to any one of the plurality of manual trace cross-sections, and the image forming unit forms a display image showing the confirmation cross-section at each of its moved positions, with the latest contour information two-dimensionally reflected therein.

In a desirable embodiment, based on a correction point designated within the confirmation cross-section, a cross-section containing the correction point is identified, and a trace line is corrected in the identified cross-section.

In a desirable embodiment, the contour information is corrected in the confirmation cross-section, a cross-section influenced by the correction is identified, and the correction to the contour information is reflected in a trace line within the identified cross-section.

### ADVANTAGES OF THE INVENTION

The present invention provides an apparatus that assists user operation during formation of trace lines. For example, according to a preferred embodiment, a trace guide two-dimensionally reflecting the contour information is formed in a manual trace cross-section in which a trace line is to be formed subsequently, and the user forms the trace line while referring to the trace guide. Accordingly, the user's operation burden is reduced as compared to the case where no trace guide is provided.

### BRIEF DESCRIPTION OF THE DRAWINGS

FIG. 1 is a diagram showing the overall configuration of an ultrasonic diagnostic apparatus that is preferred for practicing the present invention.

FIG. 2 is a diagram for explaining setting of a base cross-section with respect to volume data.

FIG. 3 is a diagram for explaining setting of an array of reference cross-sections.

FIG. 4 is a diagram for explaining automatic trace processing.

FIG. 5 is a diagram showing the internal configuration of a tissue extracting unit.

FIG. 6 is a diagram for explaining a trace line formation process performed by referring to a trace guide.

FIG. 7 is a diagram showing a first example of a confirmation cross-section.

FIG. 8 is a diagram showing a second example of a confirmation cross-section.

FIG. 9 is a diagram showing a first example of contour information correction.

FIG. 10 is a diagram showing a second example of contour information correction.

FIG. 11 is a diagram showing further examples of a confirmation cross-section.

FIG. 12 is a diagram for explaining interpolation processing performed for obtaining steric contour information.

FIG. 13 is a diagram showing an example in which different types of interpolation processing are used in combination.

### EMBODIMENTS OF THE INVENTION

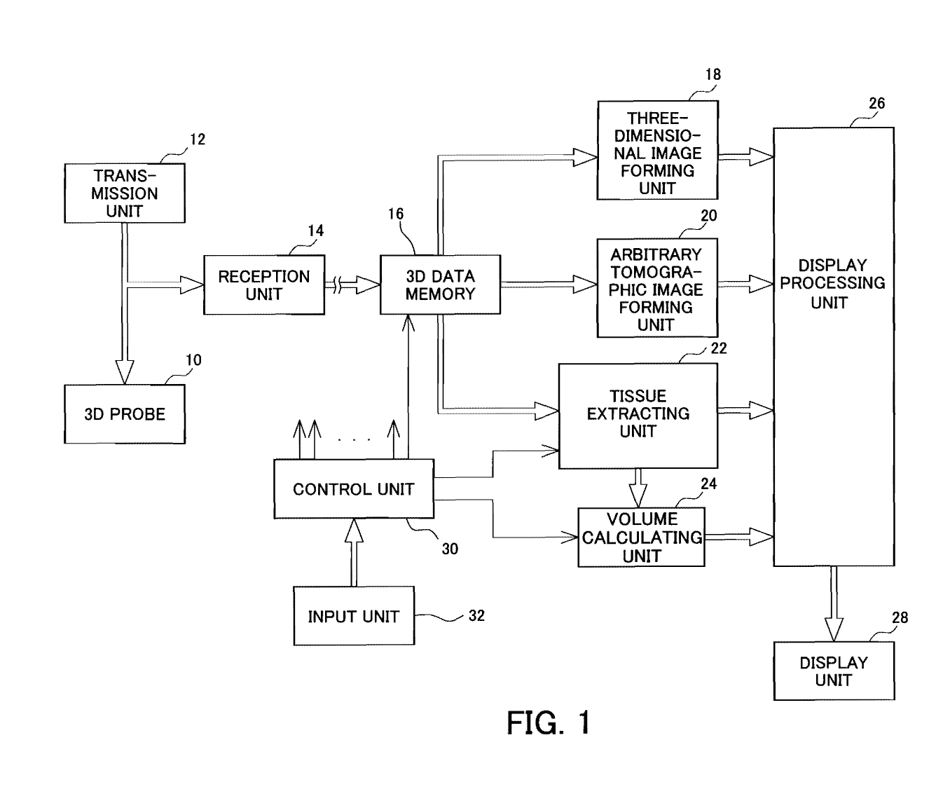

One preferred embodiment of an ultrasound data processing apparatus according to the present invention is an ultrasonic diagnostic apparatus. FIG. 1 is a diagram showing the overall configuration of an ultrasonic diagnostic apparatus that is preferred for practicing the present invention. This ultrasonic diagnostic apparatus is used in the medical field, and has the function of extracting a target tissue located particularly in a living body, and calculating the volume of the target tissue. Examples of the target tissue include placenta, malignant tumor, gallbladder, thyroid, and the like.

In FIG. 1, a 3D probe 10 is an ultrasound transmitter/receiver device that is used by being placed in contact with a body surface or by being inserted into a body cavity, for example. In the present embodiment, the 3D probe 10 includes a 2D-array oscillator. The 2D-array oscillator is constituted with a plurality of oscillating elements aligned along a first direction and a second direction. The 2D-array oscillator generates an ultrasound beam, and two-dimensional scan is performed with this ultrasound beam. As a result, a three-dimensional echo data capture space in the form of a three-dimensional space is established. More specifically, this three-dimensional space is configured as a set of plurality of scan planes, and each scan plane is formed by performing one-dimensional scan with an ultrasound beam. Instead of using a 2D-array oscillator, a similar three-dimensional space can alternatively be formed by mechanically scanning with a 1D-array oscillator.

A transmission unit 12 functions as a transmission beam former. The transmission unit 12 supplies, to the above-noted 2D-array oscillator, a plurality of transmission signals having a predetermined delay relationship, and a transmission beam is thereby formed. A reflected wave from the living body is received by the 2D-array oscillator, and, as a result, a plurality of reception signals are output from the 2D-array oscillator to a reception unit 14. The reception unit 14 executes phased summing processing with respect to the reception signals, and outputs the phased summed reception signal (beam data). This reception signal is subjected to predetermined signal processing such as detection and logarithmic transformation, and beam data obtained after subjecting the reception signal to the signal processing are stored in a 3D data memory 16.

The 3D data memory 16 has a three-dimensional memory space that corresponds to the three-dimensional space serving as the wave transmission/reception space within the living body. When writing into or reading out from the 3D data memory 16, coordinate conversion is executed for each set of data. In the present embodiment, when writing into the 3D data memory 16, coordinate conversion from a transmission/reception coordinate system to a memory space coordinate system is carried out. As a result, volume data are generated as described below. The volume data are a set of plurality of sets of frame data (slice data) corresponding to the plurality of scan planes, and each set of frame data is composed of a plurality of sets of beam data. Each set of beam data is composed of a plurality of sets of echo data that are aligned along the depth direction. Incidentally, the elements of the present embodiment including the 3D data memory 16 and all elements downstream thereof can be configured as special-purpose hardware or can alternatively be implemented as software functions. For example, each of the elements including the 3D data memory 16 and all elements downstream thereof may be implemented within a computer.

A three-dimensional image forming unit 18 executes, with respect to the volume data stored in the 3D data memory 16, image processing according to a volume rendering method, for example, and thereby generates a three-dimensional ultrasound image. This image data are transmitted to a display processing unit 26. An arbitrary tomographic image forming unit 20 serves to form a tomographic image corresponding to an arbitrary cross-section designated by the user within the three-dimensional space. When performing this processing, a data array corresponding to the arbitrary cross-section is readout from inside the 3D data memory 16, and, based on this data array, a B mode image corresponding to an image of the arbitrary cross-section is generated. This image data are transmitted to the display processing unit 26.

A tissue extracting unit 22 serves to extract the target tissue (i.e., target tissue data) contained within the three-dimensional space or the volume data by performing trace processing detailed in Patent Document 1 (JP 2008-142519 A). When performing this processing, manual trace processing and interpolation processing are used in combination, and, with respect to the results of each processing, automatic correction processing is applied. Further, in the present embodiment, the tissue extracting unit 22 carries out a processing that is favorable in terms of both burden on the user and accuracy of trace lines. This processing by the tissue extracting unit 22 is described later in detail. The extracted target tissue data are transmitted to the display processing unit 26 for use in displaying an image of the target tissue, and are also transmitted to a volume calculating unit 24.

The volume calculating unit 24 is a module that determines the volume of the target tissue using a volume calculation method such as the disk summation method. Specifically, since the tissue extracting unit 22 generates an array of trace lines in the form of a plurality of closed loops over the entire target tissue, the volume value of the target tissue is approximated based on those trace lines. For this approximation, the distances between the respective closed loops (i.e., the respective cross-sections) are also used. Data of the calculated volume value are transmitted to the display processing unit 26. As the volume calculation method, it is alternatively possible to use the average rotation method or the like.

Each of the above-noted modules, including the three-dimensional image forming unit 18, the arbitrary tomographic image forming unit 20, and the tissue extracting unit 22, functions according to an operation mode selected by the user, and the display processing unit 26 receives input of data corresponding to each selected mode. The display processing unit 26 performs image synthesis processing, coloring processing, and the like with respect to the input data, and outputs the resulting data to a display unit 28. The display unit 28 displays, according to the selected operation mode, a three-dimensional ultrasonic image, an arbitrary tomographic image, a three-dimensional image of the extracted tissue, the volume value, and the like. Here, it is possible to provide a display by synthesizing the three-dimensional image of the entire three-dimensional space and the three-dimensional image of the target tissue.

A control unit 30 controls operation of the respective elements shown in FIG. 1. Specifically, the control unit 30 controls operations in the above-described tissue extraction processing and volume calculation based on parameters designated by the user via an input unit 32. Further, the control unit 30 is in charge of control for writing data into the 3D data memory 16. The input unit 32 is constituted with a console panel having a keyboard, a trackball, and the like. The control unit 30 is constituted with a CPU, an operation program, and the like. There may be used a configuration such that a single CPU executes the three-dimensional image processing, the arbitrary tomographic image formation processing, the tissue extraction processing, and the volume calculation.

Next, the target tissue extraction processing according to the present embodiment is specifically described. Concerning the elements (units) already described by reference to FIG. 1, the reference numerals used in FIG. 1 are similarly used in the following description. The ultrasonic diagnostic apparatus of FIG. 1 executes the trace processing described in Patent Document 1. While the trace processing is as detailed in Patent Document 1, a summary thereof is given below.

First, the 3D probe 10 is used to collect data three-dimensionally, and volume data are constructed inside the 3D data memory 16. Subsequently, while displaying an arbitrary tomographic image obtained from the volume data, the position of this cross-section is adjusted as appropriate in accordance with user operation, for example, whereby a base cross-section is designated.

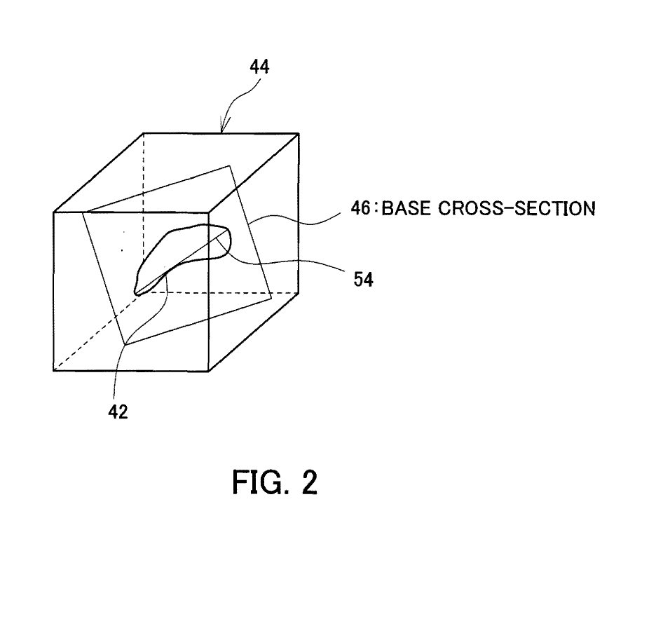

FIG. 2 is a diagram for explaining setting of a base cross-section with respect to volume data. For this setting, it is desirable to select the position of the base cross-section 46 so that the entire target tissue 42 appears in the cross-section (e.g., so that the cross-section has the maximum size). Here, since an array of reference cross-sections in the form of a set of cross-sections is to be set as explained below, the base cross-section 46 is set sufficiently so long as the reference cross-sections would cover the entire target tissue 42.

When the base cross-section 46 is set, a tomographic image corresponding to the base cross-section 46 (i.e., a tomographic image containing a tomogram of the target tissue 42) is displayed, and, in this tomographic image, two terminal points of the target tissue 42 are set by the user. Further, a straight line connecting between those two points is set as a baseline 54. When the baseline 54 is set, an array of reference cross-sections is set with respect to the volume data 44 corresponding to the three-dimensional space.

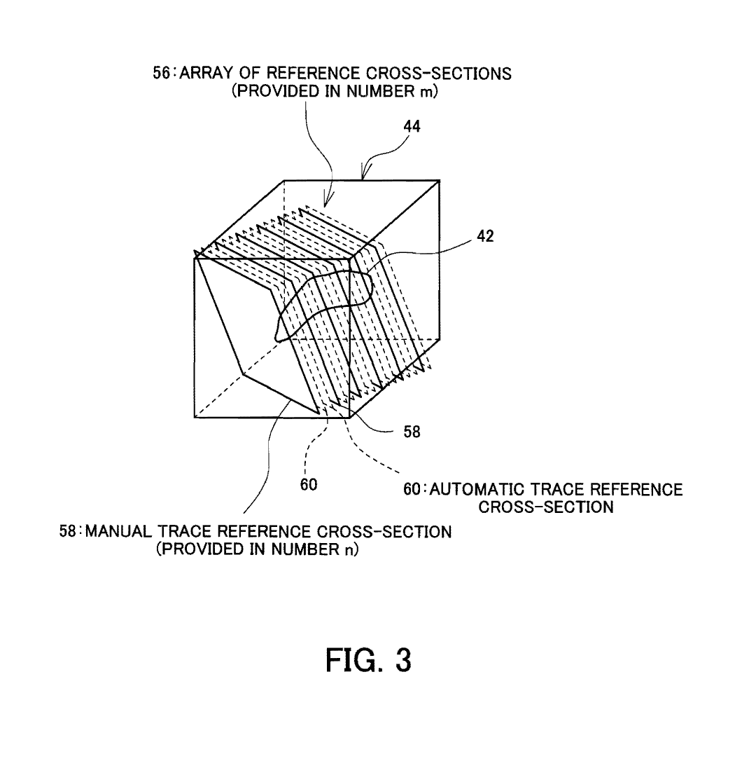

FIG. 3 is a diagram for explaining setting of an array of reference cross-sections. The reference cross-section array 56 is configured as a plurality of cross-sections orthogonal to the baseline (reference numeral 54 in FIG. 2). In other words, the reference cross-section array 56 corresponds to a plurality of cross-sections arranged at uniform or non-uniform intervals from one terminal point to the other terminal point which were used to set the baseline. Here, the reference cross-section array 56 includes at least one manual trace reference cross-section 58 and a plurality of automatic trace reference cross-sections 60. A predetermined number of manual trace reference cross-sections 58 are formed, and this number is denoted by n. For example, the value of n is set to a value within a range approximately between one and ten. The manual trace reference cross-sections 58 correspond to representative cross-sections, and manual tracing is performed only in these representative cross-sections, so that the user's burden is greatly reduced. Meanwhile, in each of the automatic trace reference cross-sections 60, automatic tracing is executed through interpolation processing.

During the manual tracing, n tomographic images corresponding to the at least one manual trace reference cross-section 58 (i.e., n manual trace reference cross-sections 58) are displayed on the display unit 28. At that time, the tomographic images may be displayed one by one, or a plurality of tomographic images may be displayed simultaneously side by side. With respect to each tomographic image, manual trace processing is executed. That is, the user forms a trace line corresponding to the contour of the target tissue within each tomographic image using the input unit 32 while viewing the image.

When the manual trace line is formed, processing for automatic correction of manual trace line as detailed in Patent Document 1 is executed for each manual trace reference cross-section 58. Specifically, for each point on the manual trace line, edge detection processing is carried out with respect to the periphery of that point. When an edge is detected for the point, processing is performed to shift that point to a location on the edge. On the other hand, when no edge is detected, the manual-trace result is stored as is. After execution of the correction processing with respect to each manual trace line, the automatic trace processing is performed for the automatic trace reference cross-sections 60.

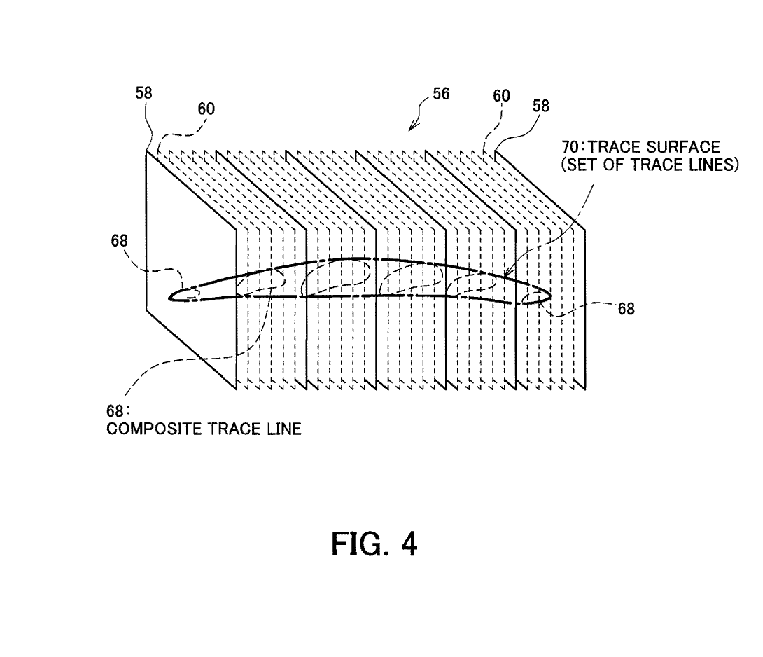

FIG. 4 is a diagram for explaining the automatic trace processing. The automatic trace processing uses, as its base, a plurality of composite trace lines 68 corresponding to the plurality of manual trace lines after being subjected to the above correction processing, which are formed in the plurality of manual trace reference cross-sections 58. By performing interpolation processing on the basis of the composite trace lines 68, a trace surface 70 is constructed, which is configured as a plurality of closed loops joined together in sheet form. At that time, although it is not necessary to define a complete three-dimensional curved surface, the interpolation processing is executed so as to be able to at least define an interpolation trace line (automatic trace line) for each individual automatic trace reference cross-section 60. Here, when only one manual trace reference cross-section 58 is set on the baseline, the above-described interpolation processing is executed between the manual trace reference cross-section 58 and the two terminal points of the target tissue. Also, when a plurality of manual trace reference cross-sections 58 are set, concerning each of the cross-sections that are located most proximate to the terminal points, the above-described interpolation processing is similarly executed between the most proximate cross-section and the corresponding terminal point.

Further, for each automatic trace reference cross-section 60, processing for automatic correction of interpolation trace line (automatic trace line) as detailed in Patent Document 1 is executed. Specifically, for each point on the interpolation trace line, edge detection processing is carried out with respect to the periphery of that point. When an edge is detected for the point, processing is performed to shift that point to a location on the edge. On the other hand, when no edge is detected, the automatic-traced result is stored as is.

In this way, as shown in FIG. 4, the trace surface 70 enclosing the target tissue along its shape is formed, thereby enabling three-dimensional extraction of the target tissue. Subsequently, a three-dimensional image of the extracted target tissue is displayed, and the volume value of the three-dimensionally extracted target tissue is calculated and displayed.

Further, according to the present embodiment, processing that is favorable in terms of both burden imposed on the user and accuracy of trace lines is carried out. As a result of this processing, accuracy of the trace lines can be improved while reducing the burden imposed on the user. This processing is explained below.

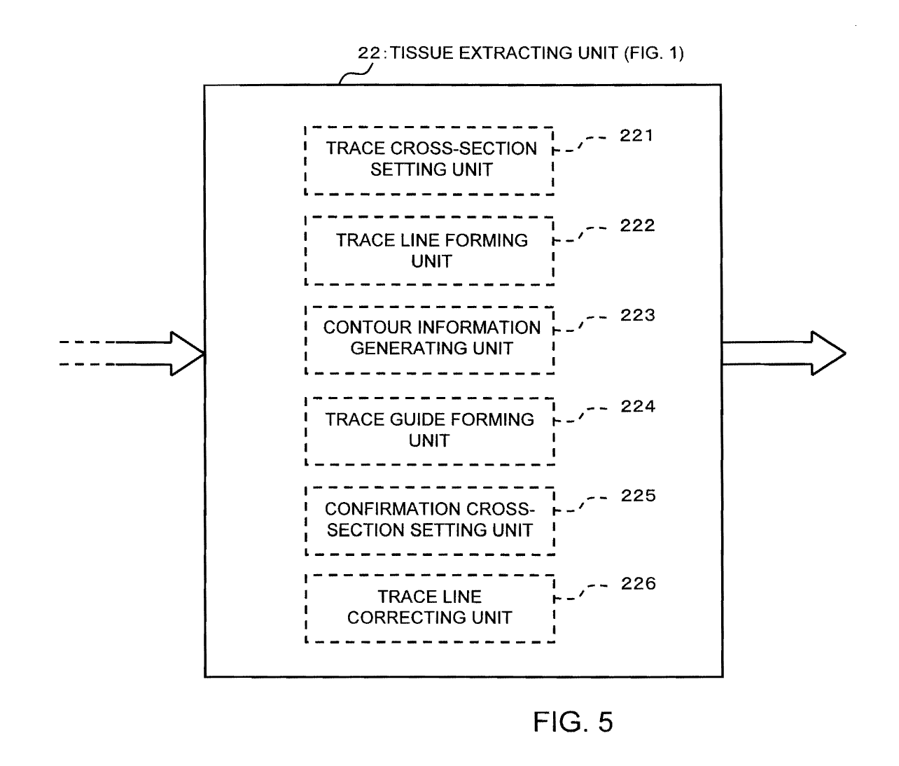

FIG. 5 is a diagram showing the internal configuration of the tissue extracting unit 22. In order to achieve the above-described tissue extraction processing and the processing detailed below, the tissue extracting unit 22 comprises a trace cross-section setting unit 221, a trace line forming unit 222, a contour information generating unit 223, a trace guide forming unit 224, a confirmation cross-section setting unit 225, and a trace line correcting unit 226. Processing performed in the tissue extracting unit 22 is explained while using the reference numerals used in FIG. 5 to refer to the elements (units) shown in FIG. 5.

The trace cross-section setting unit 221 sets, within the volume data constructed with three-dimensionally arranged ultrasound data (beam data), at least one manual trace reference cross-section 58 and a plurality of automatic trace reference cross-sections 60 with respect to the target tissue 42, as shown in FIG. 3.

Further, in each manual trace reference cross-section 58, the trace line forming unit 222 forms, in accordance with user operation, a manual trace line corresponding to the contour of the target tissue, by following the steps described below.

First, concerning a first manual trace reference cross-section 58, the user forms a trace line corresponding to the contour of the target tissue by operating the input unit 32 while viewing the image in that cross-section. When this first manual tracing process is completed, the contour information generating unit 223 executes interpolation processing between the first manual trace reference cross-section 58 and the two terminal points of the target tissue (i.e., the two endpoints of the baseline 54 in FIG. 2), and thereby generates a trace surface 70 as shown in FIG. 4 as steric contour information.

Next, the trace cross-section setting unit 221 sets a subsequent (second) manual trace reference cross-section 58. The trace guide forming unit 224 forms, within this second manual trace reference cross-section 58, a trace guide in accordance with a cross-section of the trace surface 70. Further, in that manual trace reference cross-section 58 having the trace guide formed therein, the trace line forming unit 222 forms a trace line in accordance with an operation performed by the user while referring to that trace guide.

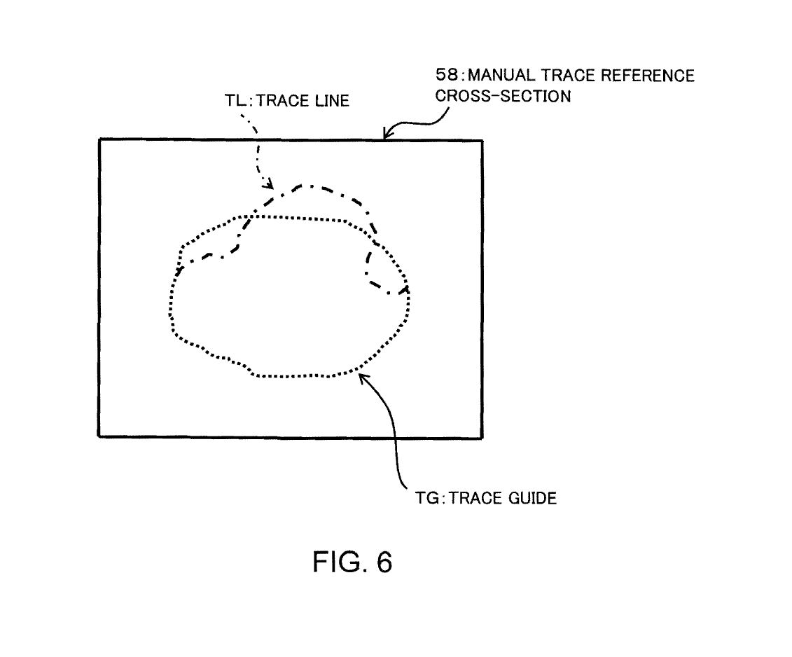

FIG. 6 is a diagram for explaining a trace line formation process performed by referring to a trace guide. In FIG. 6, a trace guide TG set within a manual trace reference cross-section 58 is shown in a dashed line. Naturally, the trace guide TG may be indicated in a format other than a dashed line. As the trace guide TG is derived from the steric contour information (trace surface 70) which is based on the already-completed first manual tracing, although the trace guide TG may not indicate a completely accurate contour, a shape approximate to the contour of the target tissue is indicated.

Accordingly, concerning the second manual trace reference cross-section 58, the user draws a trace line TL corresponding to the contour of the target tissue while referring to the trace guide TG and also checking the tomographic image of the target tissue within that manual trace reference cross-section 58. The user may draw the trace line TL in full, may use a part of the trace guide TG without alteration as the trace line TL and correct the remaining part of the trace guide TG for use as the trace line TL, or may use the trace guide TG without alteration as the trace line TL.

In consideration of performing a correction of at least a part of the trace guide TG, it is desirable to provide a configuration in which correction operations are facilitated by providing a plurality of handle points for correction on the trace guide TG and enabling the user to move the handle points using a pointer or the like. Using such a configuration, a trace line TL obtained by correcting a part of the trace guide TG is formed as shown in FIG. 6, for example.

When the second manual tracing process is completed, the contour information generating unit 223 executes interpolation processing between the first and second manual trace reference cross-sections 58 and the two terminal points of the target tissue, and thereby generates the latest trace surface 70 (FIG. 4). Further, the trace guide forming unit 224 forms, within a third manual trace reference cross-section 58, a trace guide in accordance with a boundary in a cross-section of the latest trace surface 70, and the trace line forming unit 222 forms a trace line in the third manual trace reference cross-section 58 in accordance with an operation performed by the user while referring to that trace guide.

The contour information generating unit 223 generates the latest trace surface 70 based on the manual trace reference cross-sections 58 each having a trace line already formed therein, while adding a further manual trace reference cross-section 58 every time a trace line is formed. Further, the trace guide forming unit 224 forms, within a manual trace reference cross-section 58 in which a trace line is to be subsequently formed, a trace guide two-dimensionally reflecting the latest trace surface 70.

In this way, a trace guide is always formed based on the latest trace surface 70; i.e., based on the predicted target tissue contour that is expected to have the highest accuracy at that point, and the user can form a trace line while referring to that trace guide.

The manual trace reference cross-sections 58 may be sequentially subjected to manual tracing up to a number preset in the apparatus. Alternatively, without presetting such a number, any number of manual trace reference cross-sections 58 may be sequentially subjected to manual tracing until the user is satisfied. In the case where the user performs manual tracing until satisfied, it is desirable to invite the user to confirm the tentative contour information at each manual tracing stage by, for example, displaying the tentative contour information. For example, every time the steric contour information (trace surface 70 in FIG. 4) is updated to the latest version, a three-dimensional image or image of three perpendicularly intersecting cross-sections in accordance with the latest contour information is displayed. Further, until the user judges that the displayed contour information is adequate, another manual trace reference cross-section 58 is added by the trace cross-section setting unit 221, and a manual trace line is formed in the manual trace reference cross-section 58 via the trace line forming unit 222.

Preferably, the first manual trace reference cross-section 58 is set near a center part of the target tissue, and the second and subsequent manual trace reference cross-sections 58 are added to the left and right of the center part at appropriate intervals in a balanced manner.

For the user confirmation of the contour information, a confirmation cross-section set by the confirmation cross-section setting unit 225 may be employed. The confirmation cross-section setting unit 225 sets a confirmation cross-section within the three-dimensional data space (volume data). Further, the display processing unit 26 (FIG. 1) generates a display image of the confirmation cross-section having the latest contour information two-dimensionally reflected therein. This display image is displayed on the display unit 28 (FIG. 1) and confirmed by the user.

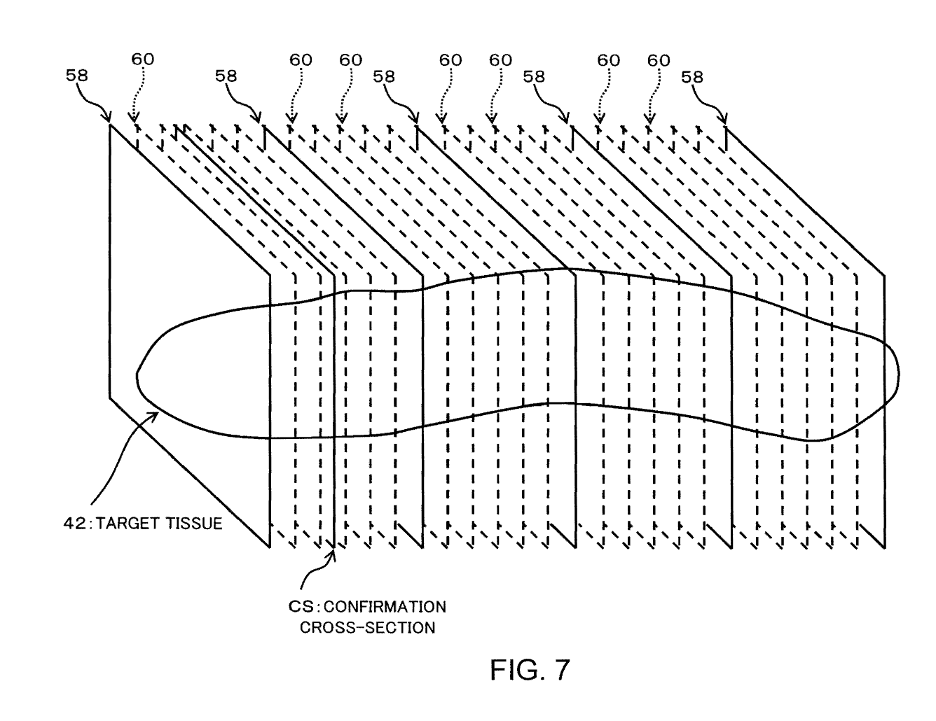

FIG. 7 is a diagram showing a first example of a confirmation cross-section CS. In FIG. 7, there is shown an array of reference cross-sections set within the volume data. Within the volume data, at least one manual trace reference cross-section 58 and a plurality of automatic trace reference cross-sections 60 are set with respect to the target tissue 42 by the trace cross-section setting unit 221 (FIG. 5).

The confirmation cross-section setting unit 225 sets a confirmation cross-section CS to be parallel to the array of reference cross-sections (i.e., the at least one manual trace reference cross-section 58 and the plurality of automatic trace reference cross-sections 60), and moves the confirmation cross-section CS while maintaining it parallel to the array of reference cross-sections. For each position to which the confirmation cross-section CS is moved, a display image two-dimensionally reflecting the latest contour information (trace surface 70 in FIG. 4) of the target tissue 42 is formed.

With this arrangement, for example, while moving the confirmation cross-section CS from one end to the other end of the target tissue 42, the user can visually confirm, at each moved position, whether or not there is any deviation in the contour information (trace surface 70 in FIG. 4) from the actual contour of the target tissue 42. During this confirmation process, when the user judges that there is a deviation at a moved position, a new manual trace reference cross-section 58 is added at that moved position of the confirmation cross-section CS. Then the user forms an accurate manual trace line while using the contour information shown in that cross-section as a trace guide, and subsequently, new contour information (trace surface 70 in FIG. 4) is generated.

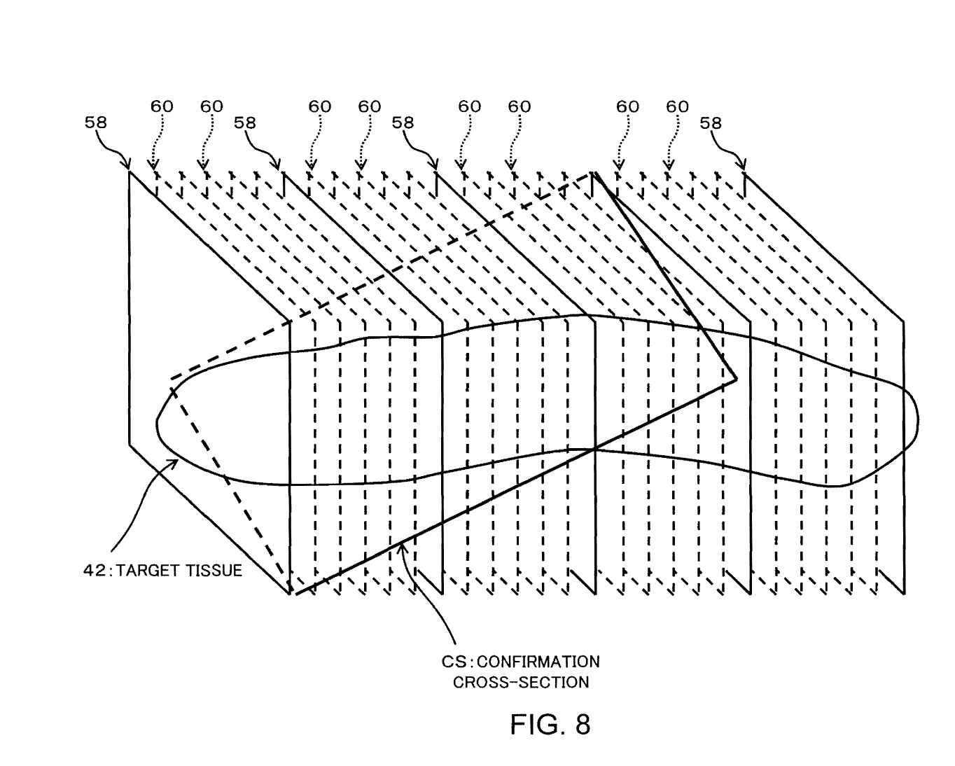

FIG. 8 is a diagram showing a second example of a confirmation cross-section CS. Similar to FIG. 7, FIG. 8 illustrates an array of reference cross-sections (at least one manual trace reference cross-section 58 and a plurality of automatic trace reference cross-sections 60) set within the volume data.

In FIG. 8, the confirmation cross-section CS is set in an arbitrary position and direction desired by the user. For example, a three-dimensional image of the target tissue 42 is displayed, and the user sets the position and direction of the confirmation cross-section CS while checking that image. Subsequently, a display image of the confirmation cross-section CS having the latest contour information (trace surface 70 in FIG. 4) two-dimensionally reflected therein is displayed, and the user visually confirms in this image whether or not there is any deviation in the contour information from the actual contour of the target tissue 42. During this confirmation process, when it is judged that there is a deviation, the contour information may be corrected within a cross-section included in the array of reference cross-sections, or may be corrected within the confirmation cross-section CS.

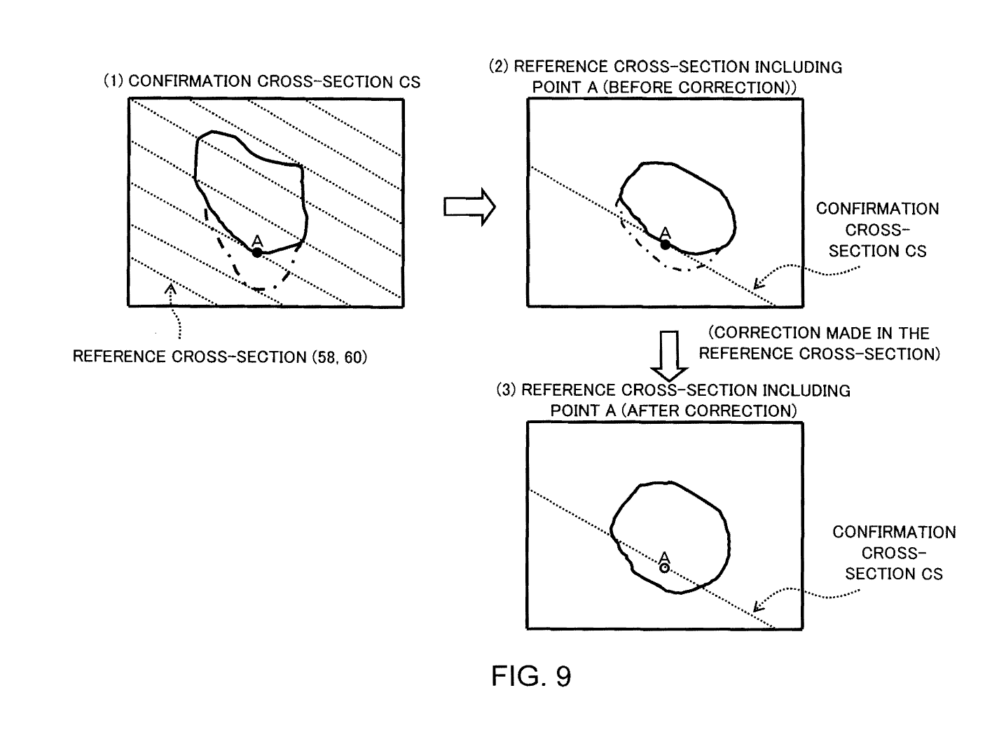

FIG. 9 is a diagram showing a first example of contour information correction. In FIG. 9(1), the confirmation cross-section CS of FIG. 8 is shown. Within this confirmation cross-section CS, a contour image two-dimensionally reflecting the contour information (trace surface 70 of FIG. 4) is indicated in a solid line, and a plurality of reference cross-sections (i.e., at least one manual trace reference cross-section 58 and a plurality of automatic trace reference cross-sections 60; see FIG. 8) intersecting the confirmation cross-section CS are indicated in dashed lines.

In the confirmation cross-section CS, while the contour image obtained from the contour information has a shape as indicated in a solid line, when the contour judged based on the image of the target tissue shown in the confirmation cross-section CS is as indicated in a dot-dash line, point A that should be corrected is designated within the confirmation cross-section CS by the user. When point A is designated, a reference cross-section including this point A is identified.

FIG. 9(2) shows a reference cross-section including point A that was set within the confirmation cross-section CS. In this reference cross-section, a contour image two-dimensionally reflecting the contour information (trace surface 70) is indicated in a solid line, and the confirmation cross-section CS is indicated in a dashed line. Within the reference cross-section shown in FIG. 9(2), the contour image is corrected. Specifically, when the contour judged based on the image of the target tissue shown in the reference cross-section is as indicated in a dot-dash line, the contour part at point A is moved to the position of the dot-dash line by the user.

As a result, as shown in FIG. 9(3), the contour part that was located at point A is moved to the position of the actual contour, and the contour parts in the vicinity of point A are also corrected so as to conform with that move. Naturally, it is also possible for the user to draw the contour line (trace line) along the actual contour. Subsequently, new contour information (trace surface 70) is generated using the corrected contour line as a trace line.

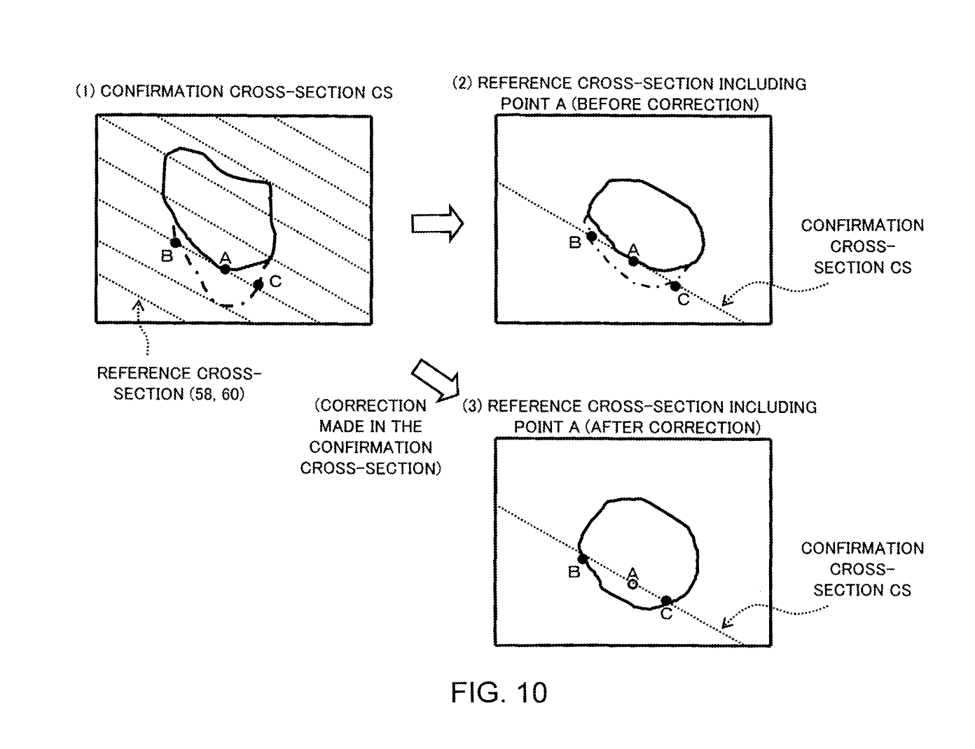

FIG. 10 is a diagram showing a second example of contour information correction. FIG. 10(1) illustrates the confirmation cross-section CS that is identical to that shown in FIG. 9(1). Within this confirmation cross-section CS, a contour image two-dimensionally reflecting the contour information is indicated in a solid line, and a plurality of reference cross-sections (i.e., at least one manual trace reference cross-section 58 and a plurality of automatic trace reference cross-sections 60) intersecting the confirmation cross-section CS are indicated in dashed lines.

In the second correction example shown in FIG. 10, the contour image is corrected within the confirmation cross-section CS. Specifically, in the confirmation cross-section CS, while the contour image obtained from the contour information has a shape as indicated in a solid line, when the contour judged based on the image of the target tissue shown in the confirmation cross-section CS is as indicated in a dot-dash line, point A that should be corrected is designated within the confirmation cross-section CS by the user, and the contour part at point A is corrected to the position of the dot-dash line by the user. Subsequently, a reference cross-section that is influenced by that correction is identified. For example, a reference cross-section including point A is identified.

FIG. 10(2) shows a reference cross-section including point A that was set within the confirmation cross-section CS. In this reference cross-section, a contour image two-dimensionally reflecting the contour information (trace surface 70) is indicated in a solid line, and the confirmation cross-section CS is indicated in a dashed line. Furthermore, the above-described correction to the contour image is reflected in the reference cross-section shown in FIG. 10(2). For example, when the contour is corrected to the position of the dot-dash line passing through point B and point C as a result of the correction made to the confirmation cross-section CS shown in FIG. 10(1), this correction is reflected in the reference cross-section shown in FIG. 10(2) so that, as shown in FIG. 10(3), the contour is corrected to the position of the dot-dash line passing through point B and point C. Subsequently, new contour information (trace surface 70 in FIG. 4) is generated using the corrected contour line as a trace line.

Embodiments of the confirmation cross-section CS are not limited to the examples shown in FIGS. 7 and 8. It is desirable to set an appropriate confirmation cross-section CS in accordance with the manner of arrangement of the reference cross-sections.

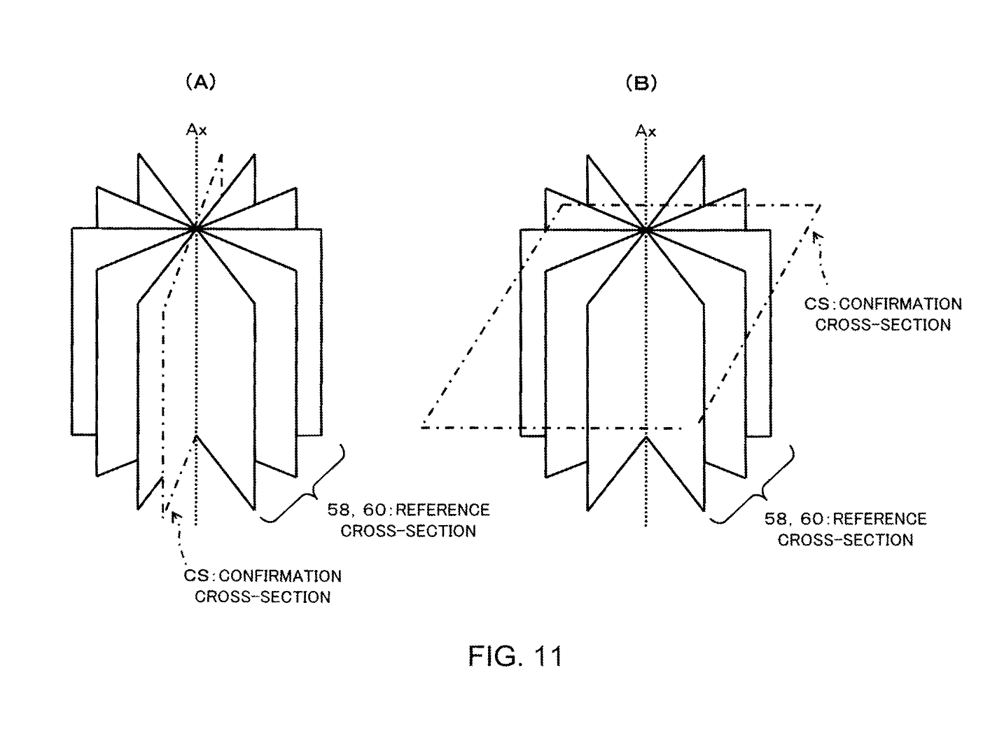

FIG. 11 is a diagram showing further examples of the confirmation cross-section. In FIG. 11(A), a plurality of reference cross-sections (i.e., at least one manual trace reference cross-section 58 and a plurality of automatic trace reference cross-sections 60) are set so as to intersect each other at a base axis Ax. For example, the base axis Ax is set so as to pass through the target tissue from one end to the other end. Further, in FIG. 11(A), a confirmation cross-section CS is rotated about the base axis Ax, and, at each rotated position of the confirmation cross-section CS, a display image two-dimensionally reflecting the contour information is formed.

In FIG. 11(B), with respect to the plurality of reference cross-sections (i.e., at least one manual trace reference cross-section 58 and a plurality of automatic trace reference cross-sections 60) set so as to intersect each other at the base axis Ax, a confirmation cross-section CS is set in an arbitrary position and direction desired by the user. Within the set confirmation cross-section CS, a display image two-dimensionally reflecting the contour information is formed.

Next, interpolation processing performed by the contour information generating unit 223 (FIG. 5) is described. The contour information generating unit 223 performs interpolation processing as shown in FIG. 4 on the basis of a plurality of manual trace lines (i.e., a plurality of composite trace lines 68) formed in a plurality of manual trace reference cross-sections 58, and thereby generates a trace surface 70 (i.e., steric contour information) configured as a plurality of closed loops joined together in sheet form.

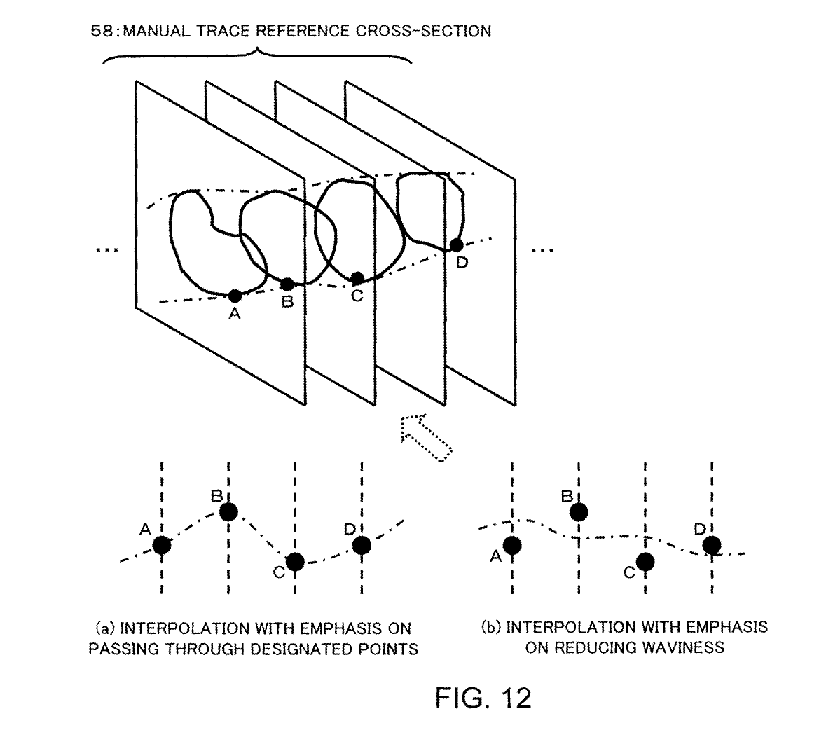

FIG. 12 is a diagram for explaining the interpolation processing performed for obtaining steric contour information. In the interpolation processing, a plurality of manual trace lines obtained from a plurality of manual trace reference cross-sections 58 are used as the basis. For example, as shown in FIG. 12, the interpolation processing is performed between designated points A, B, C, D, and so on, to thereby generate an interpolation curve connecting between those designated points.

(a) in FIG. 12 illustrates interpolation processing in which emphasis is placed on generating an interpolation curve (shown in a dot-dash line) that infallibly passes through the plurality of designated points. For example, by using a spline as the algorithm for the interpolation processing, the interpolation processing shown at (a) can be achieved. Since the designated points are obtained from the plurality of manual trace lines formed by the user, it can be said that the processing of (a) is interpolation processing with importance placed on the manual trace lines formed by the user.

Meanwhile, (b) in FIG. 12 illustrates interpolation processing in which emphasis is placed on reducing waviness of the interpolation curve (shown in a dot-dash line). For example, by using a Bezier function as the algorithm for the interpolation processing, the interpolation processing shown at (b) can be achieved. According to the interpolation processing of (b), it is possible to reduce wavy fluctuations in the interpolation curve even when, for example, the positions of the plurality of designated points are shifted far from each other.

As each type of interpolation processing has its unique advantages as described above, for example, a configuration may be provided to allow the user to select either one of the interpolation processing of (a) that places emphasis on passing through the designated points and the interpolation processing of (b) that places emphasis on reducing waviness. Naturally, it is also possible to use these two types of interpolation processing in combination.

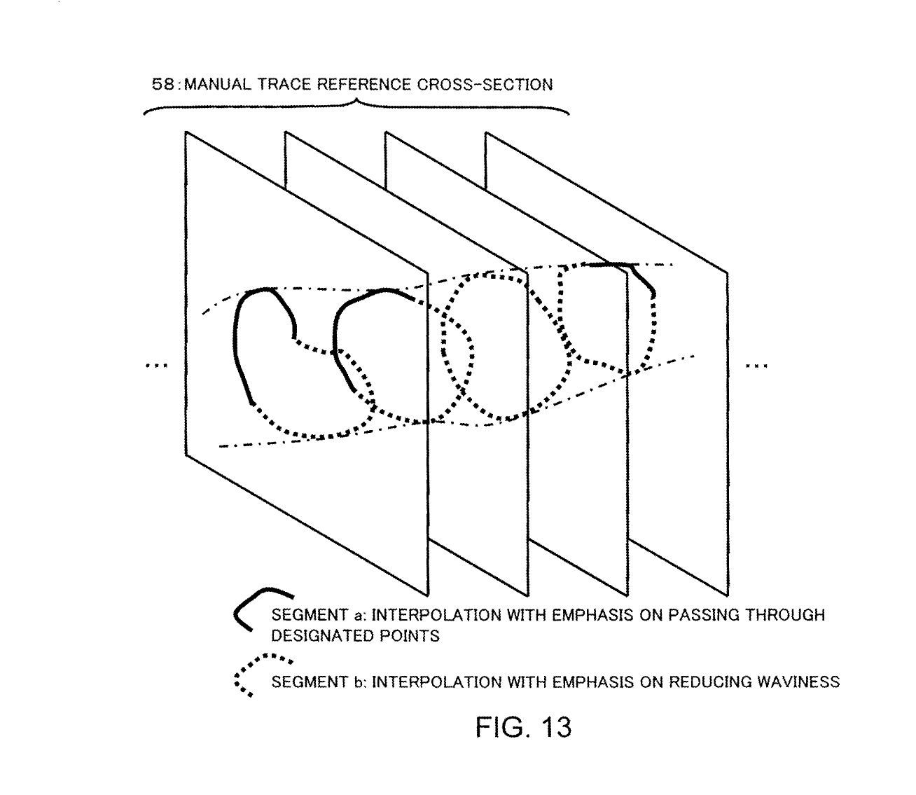

FIG. 13 is a diagram showing an example in which different types of interpolation processing are used in combination. In FIG. 13, a plurality of manual trace reference cross-sections 58 are illustrated, and a manual trace line is shown within each manual trace reference cross-section 58. The manual trace lines formed in the manual trace reference cross-sections 58 include “segment a” portions indicated in solid lines and “segment b” portions indicated in dashed lines.

When performing an interpolation processing on the basis of the plurality of manual trace lines obtained from the plurality of manual trace reference cross-sections 58, the “segment a” portions are subjected to the interpolation processing that places emphasis on passing through the designated points, and the “segment b” portions are subjected to the interpolation processing that places emphasis on reducing waviness.

For example, the user designates, as “segment a,” the trace line portions that the user can confidently believe to be boundaries when confirming in tomographic images, and designates the remaining trace line portions as “segment b.” Alternatively, the apparatus may make a search in the vicinity of a trace line for a boundary of the target tissue. In that case, if a boundary is found in the vicinity of a trace line portion, the apparatus may designate that trace line portion as “segment a,” and if no boundary is found in vicinity, the apparatus may designate that trace line portion as “segment b.”

While preferred embodiments of the present invention have been described above, the above embodiments are shown by way of examples only in all aspects, and do not serve to limit the scope of the present invention. The present invention covers various modified embodiments that are realized without deviating from the essence of the present invention.

### LIST OF REFERENCE NUMERALS

22 tissue extracting unit; 221 trace cross-section setting unit; 222 trace line forming unit; 223 contour information generating unit; 224 trace guide forming unit; 225 confirmation cross-section setting unit; 226 trace line correcting unit.

1.-14. (canceled)

15. An ultrasound data processing apparatus for processing ultrasound data obtained by transmitting and receiving ultrasound with respect to a three-dimensional space containing a target, the apparatus comprising:
a trace cross-section setting unit that sets a plurality of manual trace cross-sections within a three-dimensional data space constituted with three-dimensionally arranged ultrasound data;
a trace line forming unit that forms, in each of the manual trace cross-sections, a trace line corresponding to a contour of the target in accordance with a user operation;
a contour information generating unit that generates steric contour information of the target within the three-dimensional data space based on a manual trace cross-section having a trace line already formed therein; and
a trace assisting unit that forms, in a manual trace cross-section in which a trace line is to be formed subsequently, a trace guide two-dimensionally reflecting the contour information, wherein the trace line forming unit forms, in a manual trace cross-section having the trace guide formed therein, a trace line in accordance with an operation performed by a user while referring to the trace guide.

16. The ultrasound data processing apparatus according to claim 15, wherein
when generating the steric contour information by performing an interpolation processing on the basis of a plurality of trace lines formed in the manual trace cross-sections, the contour information generating unit generates the steric contour information using different types of interpolation processing in combination.

17. The ultrasound data processing apparatus according to claim 16, wherein
the contour information generating unit generates latest contour information based on manual trace cross-sections each having a trace line already formed therein while increasing number of the manual trace cross-sections every time a trace line is formed, and
the trace assisting unit forms, in a manual trace cross-section in which a trace line is to be formed subsequently, a trace guide two-dimensionally reflecting the latest contour information.

18. The ultrasound data processing apparatus according to claim 16, wherein
the trace line forming unit corrects a shape of the trace guide in accordance with a user operation and adopts the corrected trace guide as a trace line,
the contour information generating unit generates latest contour information based on manual trace cross-sections each having a trace line already formed therein while increasing number of the manual trace cross-sections every time a trace line is formed, and
the trace assisting unit forms, in a manual trace cross-section in which a trace line is to be formed subsequently, a trace guide two-dimensionally reflecting the latest contour information.

19. The ultrasound data processing apparatus according to claim 17, further comprising
an image forming unit that forms a display image showing the latest contour information, wherein
adequateness of the latest contour information is judged by a user via the display image, and, in accordance with the user's judgment, the trace cross-section setting unit adds a manual trace cross-section.

20. The ultrasound data processing apparatus according to claim 18, further comprising
an image forming unit that forms a display image showing the latest contour information, wherein
adequateness of the latest contour information is judged by a user via the display image, and, in accordance with the user's judgment, the trace cross-section setting unit adds a manual trace cross-section.

21. The ultrasound data processing apparatus according to claim 19, further comprising
a confirmation cross-section setting unit that sets a confirmation cross-section within the three-dimensional data space, wherein
the image forming unit forms a display image showing the confirmation cross-section with the latest contour information two-dimensionally reflected therein.

22. The ultrasound data processing apparatus according to claim 20, further comprising
a confirmation cross-section setting unit that sets a confirmation cross-section within the three-dimensional data space, wherein
the image forming unit forms a display image showing the confirmation cross-section with the latest contour information two-dimensionally reflected therein.

23. The ultrasound data processing apparatus according to claim 21, wherein
the confirmation cross-section setting unit moves the confirmation cross-section within the three-dimensional data space to be substantially parallel to any one of the plurality of manual trace cross-sections, and
the image forming unit forms a display image showing the confirmation cross-section at each of its moved positions, with the latest contour information two-dimensionally reflected therein.

24. The ultrasound data processing apparatus according to claim 22, wherein
the confirmation cross-section setting unit moves the confirmation cross-section within the three-dimensional data space to be substantially parallel to any one of the plurality of manual trace cross-sections, and
the image forming unit forms a display image showing the confirmation cross-section at each of its moved positions, with the latest contour information two-dimensionally reflected therein.

25. The ultrasound data processing apparatus according to claim 21, wherein
based on a correction point designated within the confirmation cross-section, a cross-section containing the correction point is identified, and a trace line is corrected in the identified cross-section.

26. The ultrasound data processing apparatus according to claim 23, wherein
based on a correction point designated within the confirmation cross-section, a cross-section containing the correction point is identified, and a trace line is corrected in the identified cross-section.

27. The ultrasound data processing apparatus according to claim 21, wherein
the contour information is corrected in the confirmation cross-section, a cross-section influenced by the correction is identified, and the correction to the contour information is reflected in a trace line within the identified cross-section.

28. The ultrasound data processing apparatus according to claim 23, wherein
the contour information is corrected in the confirmation cross-section, a cross-section influenced by the correction is identified, and the correction to the contour information is reflected in a trace line within the identified cross-section.
